(19) United States
(12) Patent Application Publication
(10) Pub. No.: US 2025/0355637 A1
(43) Pub. Date: Nov. 20, 2025

(54) APPLICATION CREATION

(71) Applicant: Beijing Zitiao Network Technology Co., Ltd., Beijing (CN)

(72) Inventor: Yuyang Pan, Beijing (CN)

(21) Appl. No.: 18/822,786

(22) Filed: Sep. 3, 2024

(30) Foreign Application Priority Data
May 14, 2024 (CN) 202410599430.3

(51) Int. Cl. G06F 8/34; G06F 3/0484

(52) U.S. Cl. CPC G06F 8/34; G06F 3/0484

(57) ABSTRACT

The embodiments of the disclosure relate to a method, an apparatus, a device and a storage medium for creating an application. The proposed method includes: obtaining configuration information comprising interactive control information and role setting information of a target interactive scenario, the interactive control information being used to construct a first processing entity corresponding to the target interactive scenario, the first processing entity being configured to manage an interactive process of a set of interactive objects participating in the target interactive scenario based on the interactive control information, wherein the role setting information indicates a set of predetermined roles associated with the target interactive scenario; and creating a target application based on the configuration information. In this way, the embodiments of the disclosure can support creating a richer interactive scenario.

### CROSS REFERENCE

The present application claims priority to Chinese Patent Application No. 202410599430.3, filed on May 14, 2024 and entitled “APPLICATION CREATION METHOD, APPARATUS, DEVICE AND STORAGE MEDIUM”, the entirety of which is incorporated herein by reference.

### FIELD

Example embodiments of the disclosure generally relate to the field of computers, and particularly to creating an application.

### BACKGROUND

With the development of computer technologies, people can create and release various types of applications through some platforms. For example, with the development of machine learning techniques, one may quickly create an application by configuring parameters of the application, such as models used by the application, available plug-ins, and the like.

### SUMMARY

In a first aspect of the disclosure, a method for creating an application is provided. The method comprises: obtaining configuration information comprising interactive control information and role setting information of a target interactive scenario, the interactive control information being used to construct a first processing entity corresponding to the target interactive scenario, the first processing entity being configured to manage an interactive process of a set of interactive objects participating in the target interactive scenario based on the interactive control information, the role setting information indicating a set of predetermined roles associated with the target interactive scenario; and creating a target application based on the configuration information.

In a second aspect of the disclosure, an apparatus for creating an application is provided. The apparatus comprises: an obtaining module, configured to obtain configuration information comprising interactive control information and role setting information about a target interactive scenario, the interactive control information being used to construct a first processing entity corresponding to the target interactive scenario, the first processing entity being configured to manage an interactive process of a set of interactive objects participating in the target interactive scenario based on the interactive control information, the role setting information indicating a set of predetermined roles associated with the target interactive scenario; and a creating module, configured to create a target application based on the configuration information.

In a third aspect of the disclosure, an electronic device is provided. The device comprises at least one processing unit; and at least one memory coupled to the at least one processing unit and storing instructions executed by the at least one processing unit. The instructions, when executed by the at least one processing unit, causes the device to perform the method of the first aspect.

In a fourth aspect of the disclosure, a computer readable storage medium is provided. The computer readable storage medium has a computer program stored thereon, the computer program can be executed by a processor to perform operations that implement the method of the first aspect.

It should be understood that the content described in this section is not intended to limit the key features or important features of the embodiments of the disclosure, nor is it intended to limit the scope of the disclosure. Other features of the disclosure will become readily understood from the following description.

### BRIEF DESCRIPTION OF DRAWINGS

The above and other features, advantages, and aspects of various embodiments of the disclosure will become more apparent from the following detailed description taken in conjunction with the accompanying drawings. In the drawings, the same or similar reference numbers refer to the same or similar elements, wherein:

FIG. 1 illustrates a schematic diagram of an example environment.

FIG. 2 shows a flowchart of an example process of creating an application.

FIGS. 3A-3C illustrate example interfaces.

FIG. 4 illustrates a schematic structural block diagram of an example apparatus for creating an application.

FIG. 5 illustrates a block diagram of an electronic device capable of implementing various embodiments of the disclosure.

### DETAILED DESCRIPTION

Embodiments of the disclosure will be described in more detail below with reference to the accompanying drawings. While certain embodiments of the disclosure are shown in the accompanying drawings, it should be understood that the disclosure may be implemented in various forms, and should not be construed as limited to the embodiments set forth herein, but rather, these embodiments are provided for a more thorough and complete understanding of the disclosure. It should be understood that the drawings and embodiments of the disclosure are for exemplary purposes only and are not intended to limit the scope of the disclosure.

It should be noted that the headline of any section/subsection provided herein is not limiting. Various embodiments are described throughout and any type of embodiments may be included in any section/subsection. Furthermore, the embodiments described in any section/subsection may be combined in any manner with any other embodiment described in the same section/subsection and/or different sections/subsections.

In the description of the embodiments of the disclosure, the terms “include” and the like should be understood as open inclusion, i.e., “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the disclosure may relate to data of a user, acquisition and/or use of data, and the like. These aspects all follow the corresponding laws and regulations and related regulations. In the embodiments of the disclosure, all data is collected, obtained, processed, processed, forwarded, used, and the like, on the premise that the user knows and confirms. Accordingly, when the embodiments of the disclosure are implemented, the type, the usage scope, the usage scenario, and the like of the data or information that may be involved should be notified to the user and obtain the authorization of the user in an appropriate manner according to the relevant laws and regulations. The specific notification and/or authorization manner may vary according to actual situations and application scenarios, and the scope of the disclosure is not limited in this respect.

According to the solutions in the specification and the embodiments, if personal information processing is involved, the processing may be performed on the premise of having a legal basis (for example, obtaining consent of a personal information subject, or necessary for performing a fulfillment contract), and processing only within a specified or agreed range. The user's refusal to process personal information other than the necessary information required for basic functions will not affect the user's use of basic functions.

Conventionally, user support models, plug-ins, etc. are used by configuration applications to quickly create applications, such as bot. However, applications created by the user typically only support the interaction between the user and a single intelligent agent or bot. This makes the interactive scenarios that can be provided by user-created applications to be limited.

The embodiments of the disclosure provide a solution for creating an application. According to the solution, configuration information is obtained, which comprises interactive control information and role setting information of a target interactive scenario, wherein the interactive control information is used to construct a first processing entity corresponding to the target interactive scenario to enable the first processing entity to manage an interactive process of a set of interactive objects participating in the target interactive scenario based on the interactive control information, the role setting information indicates a set of predetermined roles associated with the target interactive scenario. A target application is created based on the configuration information.

Based on the foregoing process, embodiments of the disclosure can obtain interactive control information and role setting information of a target interactive scenario, and create a target application based on the configuration information. Therefore, the embodiments of the disclosure can support the creation of richer interactive scenarios, and improve the flexibility of application development.

Various example implementations of this solution are described in detail below in conjunction with the accompanying drawings.

### Example Environment

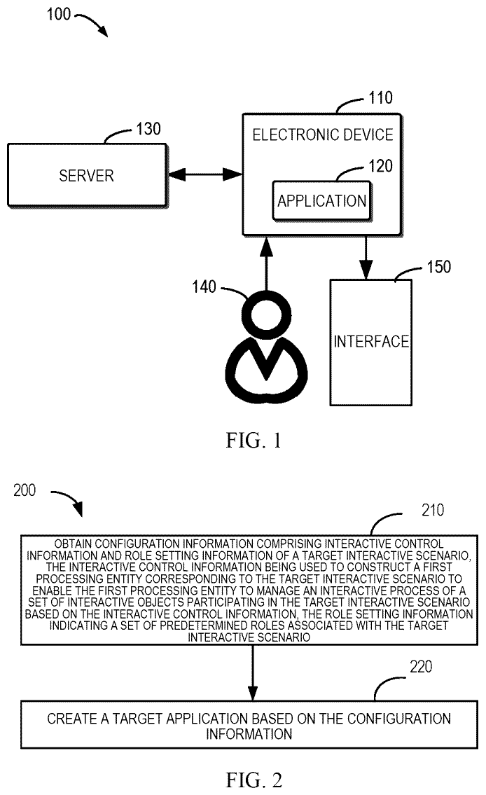

FIG. 1 illustrates a schematic diagram of an example environment 100 in which embodiments of the disclosure can be implemented. As shown in FIG. 1, the example environment 100 may include an electronic device 110.

In the example environment 100, the electronic device 110 may run an application 120 that supports interface interaction. The application 120 may be any suitable type of application for interface interaction, examples of which may include, but are not limited to, development applications or other suitable applications that support application development. A user 140 may interact with the application 120 via the electronic device 110 and/or its attachment device.

In the environment 100 of FIG. 1, if the application 120 is in an active state, the electronic device 110 may present, via the application 120, an interface 150 for supporting creation of an application.

In some embodiments, the electronic device 110 communicates with the server 130 to enable provisioning of services to the application 120. The electronic device 110 may be any suitable type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an ebook device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, a server cluster composed of multiple physical servers, or a distributed system, or may be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server, such as a mainframe, an edge computing node, a computing device in a cloud environment, or the like. The server 130 may provide background services for an application 120 that support virtual scenarios in the electronic device 110.

A communication connection may be established between the server 130 and the electronic device 110. The communication connection may be established in a wired manner or a wireless manner. The communication connection may include, but is not limited to, a Bluetooth connection, a mobile network connection, a universal serial bus (USB) connection, a wireless fidelity (WiFi) connection, and the like, and the embodiments of the disclosure are not limited in this aspect. In an embodiment of the disclosure, the server 130 and the electronic device 110 may implement signaling interaction through a communication connection between them.

It should be understood that the structures and functions of the various elements in the environment 100 are described for exemplary purposes only and do not imply any limitation to the scope of the disclosure.

Some example embodiments of the disclosure will be described below with continued reference to the accompanying drawings.

### Example Application Creation Process

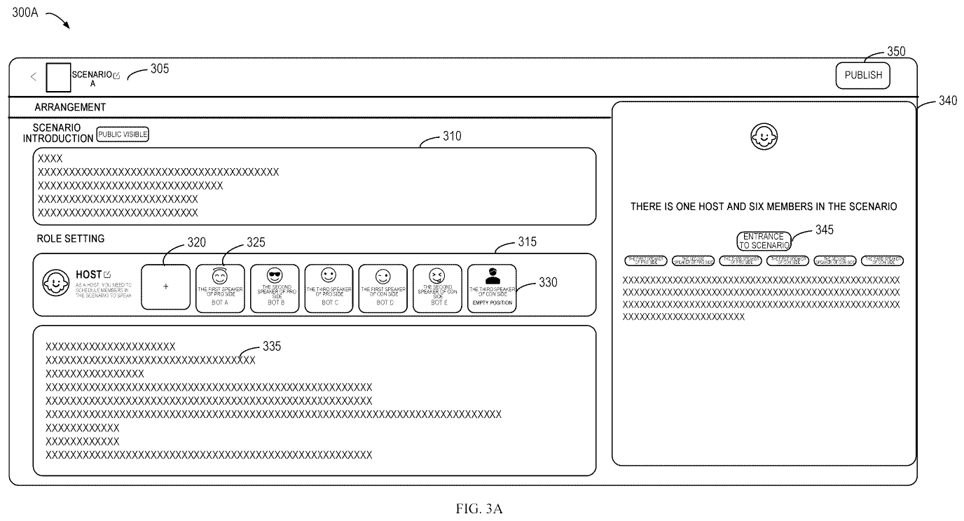

FIG. 2 shows a flowchart of a process 200 for creating an application according to some embodiments of the disclosure. Process 200 may be implemented at electronic device 110. The process 200 is described below with reference to FIG. 1.

At block 210, the electronic device 110 obtains configuration information comprising interactive control information and role setting information of a target interactive scenario. The interactive control information is used to construct a first processing entity corresponding to the target interactive scenario, to enable the first processing entity to manage an interactive process of a set of interactive objects participating in the target interactive scenario based on the interactive control information. The role setting information indicates a set of predetermined roles associated with the target interactive scenario.

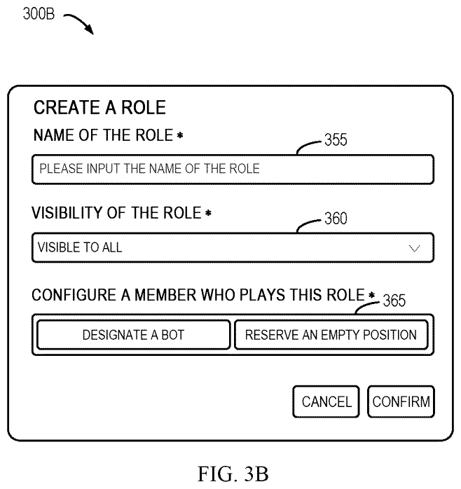

The specific obtaining process of the configuration information will be further described below with reference to FIGS. 3A to 3C. FIGS. 3A to 3C illustrate example interfaces in accordance with some embodiments of the disclosure.

As shown in FIG. 3A, the electronic device 110 may present the configuration interface 300A shown in FIG. 3A based on the creation request of the user. The configuration interface 300A may be configured to receive configuration information to create an application associated with the target interactive scenario.

As an example, the electronic device 110 may present the configuration interface 300A based on an application identifier or a scenario identifier (e.g., scenario A) 305 input by the user. As shown in FIG. 3A, the configuration interface 300A may include an input control 310 configured to obtain scenario description information of the target interactive scenario.

As an example, such scenario description information may include a piece of description text for describing an interactive scenario to be created. Such scenario description information may be public information visible to an interactive object participating in the interactive scenario. When the interactive object includes a predetermined processing entity (for example, an intelligent agent, or another application such as a bot), such scenario description information may be provided to a corresponding predetermined processing entity for controlling interaction of the predetermined processing entity in the interactive scenario.

Taking the debate scenario shown in FIG. 3A as an example, such scenario description information may include, for example, the topic of the debate, the view of the pro side, the view of the con side, and the like.

In some embodiments, as shown in FIG. 3A, the configuration interface 300A may further include a role configuration control 315, configured to obtain a set of predetermined roles associated with the target interactive scenario.

As shown in FIG. 3A, the electronic device 110 may support the user adding a plurality of predetermined roles in the interactive scenario. By taking the debate scenario as an example, the user may, for example, add a role such as the first to third speaker of the pro side and the first to third speaker of the con side.

During the interaction, a set of interactive objects participating in the interactive scenario will be assigned to corresponding predetermined roles. As will be described below, such interactive objects may for example include user objects, or may include configured processing entities, e.g., intelligent agents or bots, etc.

As shown in FIG. 3A, the electronic device 110 may provide an adding entry 320 for initiating a request to add a role. Upon receiving the selection of the adding entry 320, the electronic device 110 may present a role configuration window 300B as shown in FIG. 3B.

As shown in FIG. 3B, the electronic device 110 may provide one or more control for obtaining role description information about a role to be added. For example, the electronic device 110 may obtain the role identifier (for example, the name) of the role through the control 355.

Additionally, the electronic device 110 may further determine visibility information of the role through the control 360. The visibility information may describe whether the role information corresponding to the role is visible to another role. Taking the debate scenario as an example, the role information of each interactive object is visible to another object. In such a way, the user may set, for example, by the control 360 that the “first speaker of pro side” is visible to all roles.

As another example, in some interactive scenarios, some interactive objects need to hide their role information in a specific phase. Accordingly, the user may for example set the visibility information of the role through the control 360 to be visible only to the host (the processing entity for scheduling as will be described below).

Further, as shown in FIG. 3B, the electronic device 110 may further provide a control 365 to support the user associating the role to a predetermined processing entity or to an empty interactive object. For example, after receiving a request that the user desires to associate to the predetermined processing entity, the electronic device 110 may present the window 300C as shown in FIG. 3C.

As shown in FIG. 3C, the electronic device 110 may, for example, support a user selecting a predetermined processing entity (for example, BOT A), and associate the processing entity to the added role (for example, the first speaker of pro side). As an example, the electronic device 110 may present a set of candidate processing entities that the user has permission to add (for example, a set of Bots created by or accessible to the users), and may further select a specific processing entity to associate to the role.

As an example, the electronic device 110 may also support, for example, the user replacing the associated processing entity through the control 370. Further, the electronic device 110 may provide a control 375 to edit an identifier (for example, a nickname) of the processing entity in the target interactive scenario; and a control 380 to edit the description text of the processing entity.

In some embodiments, such an identifier and a description text may be provided to other processing entities in the interactive scenario. For example, such an identifier and a description text may be provided to a processing entity associated with another role, or a particular processing entity for scheduling, and so on.

With continued reference to FIG. 3A, the electronic device 110 may display, in the role configuration control 315, role indication element(s) corresponding to the added one or more predetermined roles, for example, a role indication element 325 and a role indication clement 330.

As shown in FIG. 3A, a role (e.g., the first speaker of pro side) corresponding to the role indication clement 325 may be associated with a specified processing entity. Correspondingly, the role indication element 325 may display an image identifier (for example, the image identifier of Bot) corresponding to the processing entity, the name of the role, and the nickname of the associated processing entity in the interactive scenario.

As another example, the role corresponding to the role indication element 330 (e.g., the third speaker of con side) is associated with the empty interactive object. In some scenarios, the association to the empty interactive object may indicate that the role is not provided with a corresponding predetermined processing entity. That is, other users may specify to participate in and associate to the role in the interactive process with the target application, or select other processing entities and associate to the role.

Specifically, if a specific role is associated with an empty interactive object, the electronic device 110 may also control the target application to provide an object configuration window for configuring a target interactive object corresponding to the role. For example, the electronic device 110 may set the user object as the target interactive object based on the configuration operation of the user, or may set the particular processing entity indicated by the user as the target interactive object.

For example, in the case where the role of “the third speaker of con side” is associated to an empty interactive object, the user may launch the application and select its own or particular processing entity (e.g., bot) as the role of “the third speaker of con side” to participate in the interactive scenario.

Accordingly, as shown in FIG. 3A, the role indication element 330 may display corresponding object information (e.g., “empty position”) to indicate that it is associated with an empty interactive object. In addition, the role indication element 330 may display predetermined image content.

Further, as shown in FIG. 3A, the configuration interface 300A may further include an input control 335 configured to obtain the interactive control information. In some embodiments, the interactive control information may include a piece of text used to describe an interactive rule and/or control logic of the interactive scenario.

In some embodiments, such interactive control information may be provided for creating a target processing entity (i.e., the host role mentioned above) in the interactive scenario. In some embodiments, the target processing entity may be configured to manage an interactive process of a plurality of interactive objects in the interactive scenario.

Continuing with the debate scenario as an example, the interactive control information may, for example, describe the whole process of the debate, the speaking order of each role, the content that the host role needs to output, and the like.

In some embodiments, such a target processing entity may be implemented based on a machine learning model. For example, the electronic device 110 may provide the interactive control information obtained by the input control 335 to the target model to instruct the target model to manage the interactive process of the plurality of interactive objects in the interactive scenario according to the content described by the interactive control information.

In some embodiments, the electronic device 110 may also provide a debugging window 340 in the configuration interface 300A. As an example, the debugging window 340 may include, for example, an entrance 345 for initiating debugging based on current configuration information.

In some embodiments, the debugging window 340 may present a session interface that a plurality of interactive objects (e.g., configured processing entities and/or user objects) corresponding to a plurality of predetermined roles may participate in. The session interface may display an interactive message generated by the plurality of interactive objects in the interactive scenario.

Continuing with the debate scenario as an example, the host role may generate an opening message based on the scenario description information and/or the interactive control information. Further, the predetermined processing entity corresponding to the respective speaker role may correspondingly generate a corresponding message according to the scenario description information and the context information in the dialog. Correspondingly, when the viewpoint needs to be published by the user object, the electronic device 110 may provide a corresponding message input control to support the user input of the corresponding interaction message.

At block 220, the electronic device 110 creates a target application based on the configuration information.

As an example, the electronic device 110 may create a corresponding target application based on the configuration information. Further, the target application may be published or shared to other users, for example. As an example, the electronic device 110 may receive a selection of the publishing control 250 by the user, to correspondingly create and publish the target application corresponding to the received configuration information.

Based on the foregoing process, embodiments of the disclosure can obtain interactive control information and role setting information of a target interactive scenario, and create a target application based on the configuration information. Therefore, the embodiments of the invention can support the creation of richer interactive scenarios, and improve the flexibility of application development.

### Example Apparatus and Device

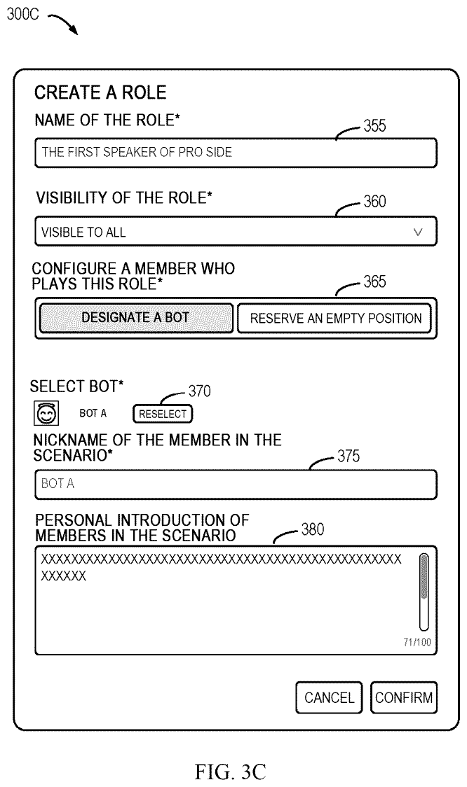

Embodiments of the disclosure also provide a corresponding apparatus for implementing the above method or process. FIG. 4 shows a schematic structural block diagram of an example apparatus 400 for creating an application according to some embodiments of the disclosure. The apparatus 400 may be implemented as or included in the electronic device 110. The various modules/components in the apparatus 400 may be implemented by hardware, software, firmware, or any combination thereof.

As shown in FIG. 4, the apparatus 400 comprises an obtaining module 410, configured to obtain configuration information comprising interactive control information and role setting information of a target interactive scenario, the interactive control information being used to construct a first processing entity corresponding to the target interactive scenario, the first processing entity being configured to manage an interactive process of a set of interactive objects participating in the target interactive scenario based on the interactive control information. The role setting information indicates a set of predetermined roles associated with the target interactive scenario. The apparatus 400 also includes a creating module 420, configured to create a target application based on the configuration information.

In some embodiments, the configuration information further comprises scenario description information of the target interactive scenario, wherein, the scenario description information is used to construct the first processing entity, or the scenario description information is provided to a second processing entity participating in the target interactive scenario.

In some embodiments, obtaining the role setting information comprises: presenting a role configuration window based on a request to add a first role associated with the target interactive scenario; and obtaining role description information of the first role through the role configuration window.

In some embodiments, the role description information comprises at least one of: a role identifier of the first role; or visibility information indicating whether the role information associated with the first role is visible to another role.

In some embodiments, obtaining the role setting information comprises: receiving a selection of a third processing entity via the role configuration window; and associating the third processing entity to the first role as a predetermined interactive object in the target interactive scenario.

In some embodiments, the role setting information further indicates at least one of: an identifier of the third processing entity in the target interactive scenario; or a description text of the third processing entity.

In some embodiments, the apparatus further comprises a controlling module, configured to: in response to a second role of the set of predetermined roles being associated to an empty interactive object, controlling the target application to provide an object configuration window for configuring a target interactive object corresponding to the second role.

In some embodiments, the target interactive object comprises: a user object, or a fourth processing entity determined based on a configuration operation.

In some embodiments, the obtaining module 410 is further configured to obtain the configuration information via a configuration interface, wherein the configuration interface presents a set of role indication elements corresponding to the set of predetermined roles.

In some embodiments, the role indication element indicates a role name of a respective role and object information corresponding to the respective role, and the object information indicates an interactive object associated with the respective role.

In some embodiments, the apparatus 400 further comprises a display module configured to: display an entity description content of the predetermined processing entity using the role indication element in response to the respective role being associated to a predetermined processing entity; or displaying a predetermined content using the role indication element in response to the respective role being associated to an empty interactive object.

In some embodiments, the apparatus 400 further comprises a debugging module configured to: display a debugging session window corresponding to the configuration information in the configuration interface, wherein the debugging session window is used to present an interactive message among the set of interactive objects.

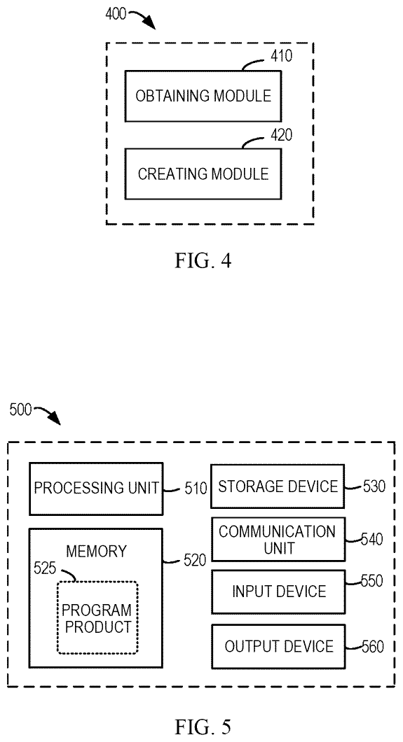

FIG. 5 illustrates a block diagram of an electronic device 500 in which one or more embodiments of the disclosure may be implemented. It should be understood that the electronic device 500 illustrated in FIG. 5 is merely exemplary and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, a plurality of processing units execute computer-executable instructions in parallel to improve parallel processing capabilities of electronic device 500.

The electronic device 500 typically comprises a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium, which is capable of storing information and/or data and may be accessible within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the disclosure.

The communication unit 540 is configured to communicate with another electronic device through a communication medium. Additionally, the functionality of components of the electronic device 500 may be implemented in a single computing cluster or a plurality of computing machines capable of communicating over a communication connection. Thus, the electronic device 500 may operate in a networked environment using logical connections with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown), such as storage devices, display devices, etc., through the communication unit 540 as needed, communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the disclosure, there is provided a computer-readable storage medium having computer-executable instructions stored thereon, wherein the computer-executable instructions are executed by a processor to implement the method described above. According to example implementations of the disclosure, a computer program product is further provided, which is tangibly stored on a non-transitory computer-readable medium and includes computer-executable instructions, the computer-executable instructions are executed by a processor to implement the method described above.

Various aspects of the disclosure are described herein with reference to flowcharts and/or block diagrams of methods, apparatuses, devices, and computer program products implemented in accordance with the disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means for implementing the functions/acts specified in the flowchart and/or block diagram. These computer-readable program instructions may also be stored in a computer-readable storage medium that cause the computer, programmable data processing apparatus, and/or other devices to operate in a particular manner. Thus, the computer-readable medium storing instructions includes an article of manufacture including instructions to implement aspects of the functions/acts specified in one or more blocks in the flowchart and/or block diagram.

The computer-readable program instructions may be loaded onto a computer, other programmable data processing apparatus, or other devices, such that a series of operational steps are performed on a computer, other programmable data processing apparatus, or other devices to produce a computer-implemented process, such that the instructions executed on a computer, other programmable data processing apparatus, or other devices implement the functions/acts specified in one or more blocks in the flowchart and/or block diagram.

The flowchart and block diagrams in the figures show architecture, functionality, and operation of possible implementations of systems, methods, and computer program products according to various implementations of the disclosure. In this regard, each block in the flowchart or block diagram may represent a module, program segment, or a portion of an instruction that includes one or more executable instructions for implementing the specified logical function. In some alternative implementations, the functions noted in the blocks may also occur in a different order than noted in the figures. For example, two consecutive blocks may actually be performed substantially in parallel, or may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations. practical applications, or improvements to techniques in the marketplace, or to enable others of ordinary skill in the art to understand the various implementations disclosed herein.

1. A method for creating an application, comprising:
obtaining configuration information comprising interactive control information and role setting information of a target interactive scenario, the interactive control information being used to construct a first processing entity corresponding to the target interactive scenario, the first processing entity being configured to manage an interactive process of a set of interactive objects participating in the target interactive scenario based on the interactive control information, wherein the role setting information indicates a set of predetermined roles associated with the target interactive scenario; and
creating a target application based on the configuration information.

2. The method according to claim 1, wherein the configuration information further comprises scenario description information of the target interactive scenario,
wherein, the scenario description information is used to construct the first processing entity, or the scenario description information is provided to a second processing entity participating in the target interactive scenario.

3. The method according to claim 1, wherein obtaining the role setting information comprises:
presenting a role configuration window based on a request to add a first role associated with the target interactive scenario; and
obtaining role description information of the first role through the role configuration window.

4. The method according to claim 3, wherein the role description information comprises at least one of:
a role identifier of the first role; or
visibility information indicating whether the role information associated with the first role is visible to another role.

5. The method according to claim 3, wherein obtaining the role setting information comprises:
receiving a selection of a third processing entity via the role configuration window; and
associating the third processing entity to the first role as a predetermined interactive object in the target interactive scenario.

6. The method according to claim 5, wherein the role setting information further indicates at least one of:
an identifier of the third processing entity in the target interactive scenario; or
a description text of the third processing entity.

7. The method according to claim 1, further comprising:
in response to a second role of the set of predetermined roles being associated with an empty interactive object, controlling the target application to provide an object configuration window for configuring a target interactive object corresponding to the second role.

8. The method according to claim 7, wherein the target interactive object comprises:
a user object; or
a fourth processing entity determined based on a configuration operation.

9. The method according to claim 1, wherein obtaining the configuration information comprises:
obtaining the configuration information via a configuration interface, the configuration interface presenting a set of role indication elements corresponding to the set of predetermined roles.

10. The method according to claim 9, wherein the role indication element indicates a role name of a respective role and object information corresponding to the respective role, and the object information indicates an interactive object associated with the respective role.

11. The method according to claim 10, further comprising:
displaying an entity description content of the predetermined processing entity using the role indication element in response to the respective role being associated to a predetermined processing entity; or
displaying a predetermined content using the role indication element in response to the respective role being associated with an empty interactive object.

12. The method according to claim 9, further comprising:
displaying a debugging session window corresponding to the configuration information in the configuration interface, the debugging session window being used to present an interactive message among the set of interactive objects.

13. An electronic device, comprising:
at least one processing unit; and
at least one memory coupled to the at least one processing unit and storing instructions executed by the at least one processing unit, the instructions, when executed by the at least one processing unit, causing the electronic device to perform the method comprising:
obtaining configuration information comprising interactive control information and role setting information of a target interactive scenario, the interactive control information being used to construct a first processing entity corresponding to the target interactive scenario, the first processing entity being configured to manage an interactive process of a set of interactive objects participating in the target interactive scenario based on the interactive control information, wherein the role setting information indicates a set of predetermined roles associated with the target interactive scenario; and
creating a target application based on the configuration information.

14. The electronic device according to claim 13, wherein the configuration information further comprises scenario description information of the target interactive scenario,
wherein, the scenario description information is used to construct the first processing entity, or the scenario description information is provided to a second processing entity participating in the target interactive scenario.

15. The electronic device according to claim 13, wherein obtaining the role setting information comprises:
presenting a role configuration window based on a request to add a first role associated with the target interactive scenario; and
obtaining role description information of the first role through the role configuration window.

16. The electronic device according to claim 15, wherein the role description information comprises at least one of:
a role identifier of the first role; or
visibility information indicating whether the role information associated with the first role is visible to another role.

17. The electronic device according to claim 15, wherein obtaining the role setting information comprises:
receiving a selection of a third processing entity via the role configuration window; and
associating the third processing entity to the first role as a predetermined interactive object in the target interactive scenario.

18. The electronic device according to claim 17, wherein the role setting information further indicates at least one of:
an identifier of the third processing entity in the target interactive scenario; or
a description text of the third processing entity.

19. The electronic device according to claim 13, further comprising:
in response to a second role of the set of predetermined roles being associated with an empty interactive object, controlling the target application to provide an object configuration window for configuring a target interactive object corresponding to the second role.

20. A non-transitory computer readable storage medium having a computer program stored thereon, the computer program can be executed by a processor to implement the method comprising:
obtaining configuration information comprising interactive control information and role setting information of a target interactive scenario, the interactive control information being used to construct a first processing entity corresponding to the target interactive scenario, the first processing entity being configured to manage an interactive process of a set of interactive objects participating in the target interactive scenario based on the interactive control information, wherein the role setting information indicates a set of predetermined roles associated with the target interactive scenario; and
creating a target application based on the configuration information.
